(19) United States
(12) Patent Application Publication
(10) Pub. No.: US 2010/0134572 A1
(43) Pub. Date: Jun. 3, 2010

(54) Ink Jet Recording Apparatus and Ink Jet Recording Method

(75) Inventors: Noriaki SATOH, Nagoya-shi (JP); Ryuji KATO, Kiyosu-shi (JP)

Correspondence Address: BANNER & WITCOFF, LTD.;ATTORNEYS FOR CLIENT NO. 016689, 1100 13th STREET, N.W., SUITE 1200, WASHINGTON, DC, 20005-4051, US

(73) Assignee: BROTHER KOGYO KABUSHIKI KAISHA, Nagoya-shi (JP)

(21) Appl. No.: 12/629,358

(22) Filed: Dec. 2, 2009

(30) Foreign Application Priority Data
Dec. 2, 2008 (JP) 2008-308011

(51) Int. Cl. B41J 2/175

(52) U.S. Cl. 347/85

(57) ABSTRACT

An ink jet recording apparatus which records information on a medium by jetting an ink onto a recording surface of the medium includes an ink accommodation section which accommodates the ink; a head which jets the ink onto the recording surface; a transporting roller which transports the medium on which the information has been recorded; and a powder supply mechanism which supplies a powder to the transporting roller. Image transfer from the recording surface of the medium to the transporting roller and image retransfer from the transporting roller to the recording surface of the following medium are inhibited and which has excellent recording quality.

### CROSS REFERENCE TO RELATED APPLICATION

The present application claims priority from Japanese Patent Application No. 2008-308011 filed on Dec. 2, 2008, the disclosures of which are incorporated herein by reference in their entirety.

### BACKGROUND OF THE INVENTION

1. Field of the Invention

The present invention relates to an ink jet recording apparatus and an ink jet recording method.

2. Description of the Related Art

Ink jet recording apparatuses have been generally used as recording apparatuses capable of high-speed and high-quality recording. In an ink jet recording apparatus, a desired image (information) is recorded by causing the ink jetted or discharged from an ink jetting mechanism to adhere to a recording surface of a recording medium. In the ink jet recording apparatus, an image and/or a letter recorded on the recording surface of the recording medium is transferred, in some cases, to a roller (transporting roller or conveying roller) disposed downstream of the ink jetting mechanism in the transporting direction of the recording medium. When the image is transferred onto the transporting roller, the image is thereafter retransferred onto the recording surface of the following recording medium and image quality is degraded. This problem is especially serious in a case that a water-base ink pigment with a low drying rate or speed is used and/or in a case that high-speed recording is required.

In order to resolve this problem, a transporting roller has been suggested in which abrasive grains, glass particles, metal particles, etc. are caused to protrude from a surface of the roller and the surface is coated (Japanese Utility Model Application Laid-open Publication No. 5-72844). In such a transporting roller, the protruding particles decrease a contact surface area of the transporting roller surface and the recording surface of the recording medium, thereby reducing the retransfer of the image to the recording surface of the following recording medium.

However, in the aforementioned transporting roller, the particles are fixedly attached to the transporting roller surface by coating. Therefore, the retransfer of image by the protruding portions of the particles still cannot be prevented or suppressed.

In a general ink jet recording apparatus, sheets of recording medium on which images have been recorded are stacked so that the following recording medium is placed on the recording surface of the preceding recording medium. In a case that a water-base or aqueous pigment ink is used that has a low drying speed and/or in a case that high-speed recording is performed, the following recording medium is stacked before the recording surface of the preceding recording medium has dried. The resultant problem is that an image is transferred on the back surface of the following recording medium (the so-called back transfer) or sheets of recording medium on which images have been recorded stick to each other.

### SUMMARY OF THE INVENTION

Accordingly, it is an object of the present invention to provide an ink jet recording apparatus and an ink jet recording method in which image (information) transfer from the recording surface of the recording medium to the transporting roller and image retransfer from the transporting roller to the recording surface of the following recording medium are suppressed or inhibited and which is excellent in the recording quality. Another object of the present invention is to provide an ink jet recording apparatus and an ink jet recording method in which, in a case that the sheets of recording medium are stacked after recording, the transfer of the image onto the following recording medium (the so-called back transfer) is prevented and the sheets of the recording medium are prevented from sticking to each other.

According to a first aspect of the present invention, there is provided an ink jet recording apparatus which records information on a medium by jetting an ink onto a recording surface of the medium, including: an ink accommodation section which accommodates the ink; a head which jets the ink onto the recording surface; a transporting roller which transports the medium on which the information has been recorded; and a powder supply mechanism which supplies a powder to the transporting roller.

According to a second aspect of the present invention, there is provided an ink jet recording method, including: recording information on a medium by jetting an ink onto a recording surface of the medium; supplying a powder to a transporting roller which transports the medium on which the information has been recorded; and transporting the medium on which the information has been recorded by the transporting roller to which the powder has been supplied.

### BRIEF DESCRIPTION OF THE DRAWINGS

FIG. 1 is a schematic view illustrating an ink jet recording apparatus of a first embodiment of the present invention;

FIG. 2A is a schematic view illustrating an ink jet recording apparatus of a second embodiment. FIG. 2B is a schematic view illustrating an ink jet recording apparatus of a third embodiment;

FIGS. 3A to 3F are views for explaining an ink jet recording method of the first embodiment;

FIG. 4 is a flowchart illustrating the ink jet recording method of the first embodiment;

FIG. 5 is a flowchart illustrating an ink jet recording method of the second embodiment;

FIG. 6 is a schematic view illustrating an ink jet recording apparatus of a fourth embodiment;

FIG. 7 is a flowchart illustrating an ink jet recording method of the fourth and fifth embodiments;

FIG. 8 is a schematic view illustrating an ink jet recording apparatus of the fifth embodiment;

FIG. 9 is a schematic view illustrating an ink jet recording apparatus of a sixth embodiment;

FIG. 10 is a flowchart illustrating an ink jet recording method of the sixth embodiment;

FIG. 11 is a schematic view illustrating an ink jet recording apparatus of a eighth embodiment, and

FIG. 12 is a flowchart illustrating an ink jet recording method of an eighth embodiment.

### DESCRIPTION OF THE PREFERRED EMBODIMENTS

Embodiments of the ink jet recording apparatus and ink jet recording method of the present invention will be explained below in greater detail. However, the present invention is not limited to the explanation below.

In the ink jet recording apparatus and ink jet recording method of the present invention, information such as image and/or text is recorded on the recording surface of the recording medium by using an ink for ink jet recording (referred to hereinbelow simply as “ink”).

The ink includes a colorant and a solvent. The colorant is not particularly limited and may be a pigment or a dye. A mixture of a pigment and a dye may be also used as the colorant. The solvent is not particularly limited and water, an organic solvent, etc. can be used.

The pigment is not particularly limited. For example, carbon black, an inorganic pigment, or an organic pigment can be used. Examples of the carbon black include furnace black, lamp black, acetylene black, and channel black. Examples of the inorganic pigment include titanium oxide, inorganic pigments of iron oxide system, and inorganic pigments of carbon black system. Examples of the organic pigment include azo pigments such as azo lake, insoluble azo pigments, condensation azo pigments, and chelate azo pigments, polycycle pigments such as phthalocyanine pigment, perylene and perinone pigments, anthraquinone pigments, quinacridone pigments, dioxazine pigments, thioindigo pigments, isoindolinone pigments, and quinophthalone pigments; dye lake pigments such as basic dye lake pigments and acidic dye lake pigments; nitro pigments; nitroso pigments; aniline black type; and the like. Other pigments can be also used, provided that they are dispersible in an aqueous phase. Specific examples of the pigments include C. I. Pigment Black 1, 6, and 7; C. I. Pigment Yellow 1, 2, 3, 12, 13, 14, 15, 16, 17, 55, 73, 74, 75, 83, 93, 94, 95, 97, 98, 114, 128, 129, 138, 150, 151, 154, 180, 185, and 194; C. I. Pigment Orange 31 and 43; C. I. Pigment Red 2, 3, 5, 6, 7, 12, 15, 16, 48, 48:1, 53:1, 57, 57:1, 112, 122, 123, 139, 144, 146, 149, 166, 168, 175, 176, 177, 178, 184, 185, 190, 202, 221, 222, 224, and 238; C. I. Pigment Violet 196; C. I. Pigment Blue 1, 2, 3, 15, 15:1, 15:2, 15:3, 15;4, 16, 22, and 60; and C. I. Pigment Green 7 and 36.

The pigments may include a self-dispersible pigment. The self-dispersible pigment is a pigment which can be made dispersible in a solvent, without using a dispersant, owing to the fact that at least one species from among hydrophilic functional groups such as a carboxyl group, a carbonyl group, a hydroxyl group, a sulfone group and salts thereof is introduced into the surfaces of the pigment particles by the chemical bond directly or with any polyvalent group intervening therebetween.

The self-dispersible pigment is not particularly limited. For example, a self-dispersible pigment subjected to surface treatment by methods described, for example, in Japanese Patent Application Laid-open No. 8-3498, Published Japanese Translation of PCT International Publication for Patent Application No. 2000-513396, etc. can be used. Commercially available self-dispersible pigments may be also used. Examples of commercial products include “CAB-O-JET (trade name) 200”, “CAB-O-JET (trade name) 250C”, “CAB-O-JET (trade name) 260M”, “CAB-O-JET (trade name) 270Y”, and “CAB-O-JET (trade name) 300” manufactured by Cabot Specialty Chemicals Co., Ltd.; “BONJET (trade name) BLACK CW-1”, “BONJET (trade name) BLACK CW-2”, “BONJET (trade name) BLACK CW-3”, manufactured by Orient Chemical Industries Ltd.; and “LIOJET (trade name) WD BLACK 002C” manufactured by Toyo Inks and Chemicals Co., Ltd.

Pigments that can be used as starting materials for the self-dispersible pigments are not particularly limited, and both the inorganic pigments and the organic pigments can be used. For example, carbon black such as “MA8” and “MA100” manufactured by Mitsubishi Chemical Corp. and “Color Black FW200” manufactured by Degussa Co. can be used as an inorganic pigment suitable for conducting the above-described surface treatment.

The blending amount or compounded amount of the pigment (pigment ratio) with respect to the total amount of the ink is not particularly limited and can be appropriately determined, for example, according to a desired optical density or chromaticity. The pigment ratio is for example, 0.1 wt % to 20 wt %, preferably 1 wt % to 10 wt %, more preferably 2 wt % to 8 wt %. The pigment of one kind may be used independently, or pigments of two or more kinds may be used together.

The dye is not particularly limited. For example, a direct dye, an acidic dye, a basic dye, or a reactive dye may be used. Specific examples of the dye include C. I. Direct Black, C. I. Direct Blue, C. I. Direct Red, C. I. Direct Yellow, C. I. Direct Orange, C. I. Direct Violet, C. I. Direct Brown, C. I. Direct Green, C. I. Acid Black, C. I. Acid Blue, C. I. Acid Red, C. I. Acid Yellow, C. I. Acid Orange, C. I. Acid Violet, C. I. Basic Black, C. I. Basic Blue, C. I. Basic Red, C. I. Basic Violet, and C. I. Food Black. Examples of the C. I. Direct Black include C. I. Direct Black 17, 19, 32, 51, 71, 108, 146, 154, and 168. Examples of C. I. Direct Blue include C. I. Direct Blue 6, 22, 25, 71, 86, 90, 106, and 199. Examples of the C. I. Direct Red include C. I. Direct Red 1, 4, 17, 28, 83, and 227. Examples of the C. I. Direct Yellow include C. I. Direct Yellow 12, 24, 26, 86, 98, 132, 142, and 173. Examples of the C. I. Direct Orange include C. I. Direct Orange 34, 39, 44, 46, and 60. Examples of the C. I. Direct Violet include C. I. Direct Violet 47 and 48. Examples of the C. I. Direct Brown include C. I. Direct Brown 109. Examples of the C. I. Direct Green include C. I. Direct Green 59. Examples of the C. I. Acid Black include C. I. Acid Black 2, 7, 24, 26, 31, 52, 63, 112, and 118. Examples of the C. I. Acid Blue include C. I. Acid Blue 9, 22, 40, 59, 93, 102, 104, 117, 120, 167, 229, and 234. Examples of the C. I. Acid Red include C. I. Acid Red 1, 6, 32, 37, 51, 52, 80, 85, 87, 92, 94, 115, 180, 256, 289, 315, and 317. Examples of the C. I. Acid Yellow include C. I. Acid Yellow 11, 17, 23, 25, 29, 42, 61, and 71. Examples of the C. I. Acid Orange include C. I. Acid Orange 7 and 19. Examples of the C. I. Acid Violet include C. I. Acid Violet 49. Examples of the C. I. Basic Black include C. I. Basic Black 2. Examples of the C. I. Basic Blue include C. I. Basic Blue 1, 3, 5, 7, 9, 24, 25, 26, 28, and 29. Examples of the C. I. Basic Red include C. I. Basic Red 1, 2, 9, 12, 13, 14, and 37. Examples of the C. I. Basic Violet include C. I. Basic Violet 7, 14, and 27. Examples of the C. I. Food black include C. I. Food Black 1 and 2. These dyes have excellent characteristics, for example, such as brightness, solubility in water, and stability.

The blending amount (dye ratio) of the dye with respect to the entire amount of the ink is not particularly limited and is, for example, 0.1 wt % to 20 wt %, preferably 1 wt % to 10 wt %, more preferably 2 wt % to 8 wt %. The dye may be used individually or in combinations of two or more thereof.

Water that is used as the solvent is preferably ion-exchange water or pure water (purified water). The blending amount of the solvent (solvent ratio) with respect to the entire amount of the ink can be appropriately determined based on the desired ink characteristics. The solvent ratio may be, for example, the balance or remainder of the other components.

As an organic solvent which is used as the solvent, the ink can further include a humectant (wetting agent) which prevents the ink from drying in a nozzle section of the ink jet head and a penetrant which adjusts the drying rate or speed on the recording medium.

The humectant is not particularly limited and can be a lower alcohol such as methyl alcohol, ethyl alcohol, n-propyl alcohol, isopropyl alcohol, n-butyl alcohol, sec-butyl alcohol, and tert-butyl alcohol; amides such as dimethylformamide and dimethylacetamide; ketones such as acetone; ketoalcohols such as diacetone alcohol; ethers such as tetrahydrofuran and dioxane; polyhydric alcohols such as a polyalkylene glycol, an alkylene glycol, and glycerin; 2-pyrrolidone; N-methyl-2-pyrrolidone; and 1,3-dimethyl-2-imidazolidinone. The polyalkylene glycol is not particularly limited and examples thereof include polyethylene glycol and polypropylene glycol. The alkylene glycol is not particularly limited and examples thereof include ethylene glycol, propylene glycol, butylene glycol, diethylene glycol, triethylene glycol, dipropylene glycol, tripropylene glycol, thiodiglycol, and hexylene glycol. Among them, polyhydric alcohols such as alkylene glycols and glycerin are preferred. The humectant may be used individually or in combinations of two or more thereof.

The blending ratio of the humectant (humectant ratio) with respect to the entire amount of the ink is not particularly limited and is, for example, 0 wt % to 95 wt %, preferably 5 wt % to 80 wt %, and more particularly 5 wt % to 50 wt %.

The penetrant is not particularly limited and examples thereof include a glycol ether. The glycol ether is not particularly limited and examples thereof include ethylene glycol methyl ether, ethylene glycol ethyl ether, ethylene glycol n-propyl ether, diethylene glycol methyl ether, diethylene glycol ethyl ether, diethylene glycol n-propyl ether, diethylene glycol n-butyl ether, diethylene glycol n-hexyl ether, triethylene glycol methyl ether, triethylene glycol ethyl ether, triethylene glycol n-propyl ether, triethylene glycol n-butyl ether, propylene glycol methyl ether, propylene glycol ethyl ether, propylene glycol n-propyl ether, propylene glycol n-butyl ether, dipropylene glycol methyl ether, dipropylene glycol ethyl ether, dipropylene glycol n-propyl ether, dipropylene glycol n-butyl ether, tripropylene glycol methyl ether, tripropylene glycol ethyl ether, tripropylene glycol n-propyl ether, and tripropylene glycol n-butyl ether. The penetrant may be used individually or in combinations of two or more thereof

The blending amount of the penetrant (penetrant ratio) with respect to the entire amount of the ink is not particularly limited and is, for example, 0 wt % to 20 wt %. By making the penetrant ratio be within this range, the penetration ability of the ink into the recording medium such as recording paper can be further improved. The penetrant ratio is preferably 0.1 wt % to 15 wt %, more preferably 0.5 wt % to 10 wt %.

If necessary, the ink may further contain a conventionally known additive. Examples of the additive include surfactants, viscosity adjusting agents, surface tension adjusting agents, fungicides (antimold agents), etc. Examples of the viscosity adjusting agents include polyvinyl alcohol, cellulose, and water-soluble resins.

The ink can be prepared, for example, by uniformly or homogeneously mixing the colorant with solvent and, if necessary, other additive component(s) by a conventional well-known method and by removing undissolved matters or insolubles with a filter or the like.

### First Embodiment

### Ink Jet Recording Apparatus

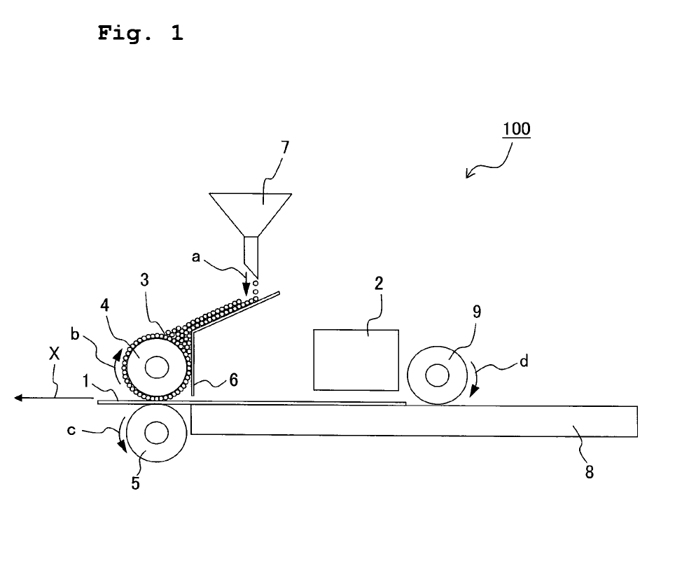

As shown in FIG. 1, an ink jet recording apparatus 100 of the present embodiment includes an ink accommodation section (not shown in the figure), an ink jet head 2, a transporting roller 4, a nip roller (counter roller) 5, a recording medium transporting guide 8, a feed roller 9, a hopper 7, and a powder supply blade 6 as the main constituent members. The ink jet head 2 in the ink jet recording apparatus 100 is the ink jetting mechanism. The hopper 7 and powder supply blade 6 constitute a powder supply mechanism. In the ink jet recording apparatus 100 of the present embodiment, the components, other than the transporting roller 4 and the powder supply mechanism (hopper 7 and powder supply blade 6), can be made similar to those of the conventional ink jet recording apparatus.

Inside the ink jet recording apparatus 100, a recording medium transporting path is formed in which the recording medium 1 is transported from a paper feed section (not shown in the figure) toward the transporting roller 4 and the nip roller 5 via the recording medium transporting guide 8. An arrow X shows a recording medium transporting direction along which the recording medium 1 is transported. The paper feed section (not shown in the figure) is disposed upstream (on the right side in FIG. 1) in the recording medium transporting direction X, and the recording medium 1 is fed out toward the recording medium transporting guide 8. The fed-out recording medium 1 is introduced in the recording medium transporting guide 8 and transported to a position below or under a paper feed roller 9.

The paper feed roller 9 is disposed on the upstream side (right side in FIG. 1) of the ink jet head 2, in the recording medium transporting direction X, and by rotating the roller in a direction shown by an arrow d, the recording medium 1 is transported to the position below the ink jet head 2. A conventional well-known roller, for example, such as that obtained by molding a rubber cylinder around a metal core can be used as the paper feed roller 9. The diameter of the paper feed roller 9 is not particularly limited and is, for example, 10 mm to 30 mm, preferably 12 mm to 20 mm. The length of the paper feed roller 9 is also not particularly limited, but it is preferred that the length is slightly greater than the width of the recording medium 1. For example, in a case that an A4-sized paper is used as the recording medium 1, the length of the paper feed roller 9 is, for example, 220 mm to 230 mm. In a case that an A3 paper is used, the length of the paper feed roller 9 is, for example, 310 mm to 330 mm.

The ink accommodation section (not shown in the figure) includes the ink for ink jet recording. Examples of the ink accommodation section include an ink cartridge. For example, a conventional well-known body of ink cartridge (ink cartridge body) can be used. The ink accommodation section supplies the ink to the ink jet head 2. The ink jet head 2 may be disposed directly below or under the ink accommodation section and may be connected or coupled to the ink accommodation section by a tube or the like. When the recording medium 1 transported by the paper feed roller 9 passes below the ink jet head 2, the ink is jetted toward the recording surface of the recording medium 1. As a result, an image is recorded on the recording surface of the recording medium 1. The recording medium 1 after recording is guided by the recording medium transporting guide 8 and transported to a space between the transporting roller 4 and the nip roller 5.

The above-described ink for ink jet recording can be used as the ink. With a water-base pigment ink in which a pigment is used as a colorant and water is mainly used as the solvent, the pigment easily remains on the surface of the recording medium and the water serving as a solvent is difficult to evaporate. As a result, the drying rate is low. However, such a water-base pigment ink can be also used in the present embodiment.

A well-known ink jet head can be used as the ink jet head 2. The ink jet recording apparatus of the present embodiment may be a serial-type ink jet recording apparatus using a serial-type ink jet head, but the ink jet recording apparatus is preferably a line-type ink jet recording apparatus using a line-type ink jet head. In the serial-type ink jet recording apparatus, the recording is performed, while the ink jet head itself moves in the width direction of the recording surface of the recording medium. On the other hand, the line-type ink jet recording apparatus includes a line-type ink jet head having a recording width that is not less than the width of the recording medium, and is capable of performing recording in the width direction of the recording medium wholly or in one cycle in a state that the ink jet head is fixed. Because the recording width that can be recorded at the same time is large in the line-type ink jet recording apparatus, the recording speed is much higher than in the serial-type ink jet recording apparatus.

The powder supply mechanism constructed of the hopper 7 and the powder supply blade 6 is disposed between the ink jet head 2 and the transporting roller 4. The hopper 7 is filled with a powder 3. The powder supply blade 6 has a substantially L-like shape which is inclined at a portion of the blade 6 located below the hopper 7 toward the downstream side (left side in FIG. 1) in the recording medium transporting direction X, then is bent at a portion of the blade 6 above the left end of the recording medium transporting guide 8 and is extended to the vicinity of the left upper end of the recording medium transporting guide 8 perpendicularly to the recording medium transporting direction X. The powder supply blade 6 has a width in a perpendicular direction which is perpendicular to the sheet surface of FIG. 1, and the width is substantially same as a width of the transporting roller 4 in the perpendicular direction. The material of the powder supply blade 6 is not particularly limited and can be, for example, a resin or a metal.

The powder 3 filled or loaded into the hopper 7 falls down to the side of the right end of the powder supply blade 6, as shown by an arrow “a”, then flows down along the inclination of the powder supply blade 6, and is supplied to the right upper portion of the transporting roller 4. By the rotation of the transporting roller 4 as shown by an arrow “b”, the powder 3 is adhered to the surface of the transporting roller 4 in a state that the powder 3 is movable (is movably adhered). The construction of the powder supply mechanism is not limited to that shown in FIG. 1, and any construction may be used provided that the powder 3 can be caused to movably adhere to the surface of the transporting roller 4. For example, the powder supply mechanism preferably includes the powder supply blade 6 to enable uniform adhesion of the powder 3 to the surface of the transporting roller 4, but such a construction is not limiting, and the powder supply mechanism may be constructed only by the hopper 7.

The term “movable state” means a state in which the powder 3 is caused to adhere to the surface of the transporting roller 4, for example, by an electrostatic force or a week adhesive force, without being fixedly attached to the surface. In the “movable state”, the powder 3 freely moves by rotation or the like over the surface of the transporting roller 4 and the powder 3 is freely removed from the surface of the transporting roller 4.

The transporting roller 4 and nip roller 5 are disposed side by side at the downstream of the recording medium transporting guide 8 in the recording medium transporting direction X perpendicularly to the recording medium transporting direction X so that the transporting roller 4 is at the side of the recording surface of the recording medium 1. By the rotation of the transporting roller 4 and the nip roller 5 in the opposite directions, as shown by the arrows “b” and “c”, the recording medium 1 is transported in a state that the powder 3 is interposed or intervened between the recording surface of the recording medium 1 and the surface of the transporting roller 4. A roller obtained by molding a rubber cylinder around a metal core and having concave portions and convex portions (irregularities) on the surface thereof for the purpose of facilitating the adhesion of the powder 3 is preferred, but such a construction is not limiting and any roller may be used provided that the powder 3 can be caused to adhere thereto. A conventional well-known roller, for example, such that is obtained by molding a rubber cylinder around a metal core can be used as the nip roller 5. The size of the transporting roller 4 and the nip roller 5 are similar to that of the paper feed roller 9.

The material of the powder 3 is not particularly limited, provided it does not dissolve in the ink solvent. For example, in a case that a lyophilic powder (a hydrophilic powder in a case that an water-base ink is used) is used, when the powder 3 that has adhered to the transporting roller 4 comes into contact with the recording surface of the recording medium 1, the ink that has not dried on the recording surface is absorbed, thereby efficiently inhibiting image transfer from the recording surface of the recording medium to the transporting roller 4. A highly absorbing powder which has high ability to absorb liquids (a powder having high water absorption ability in a case that a water-base ink is used) can be used as the powder 3 to increase the amount of absorbed ink. On the other hand, a liquid-repelling powder (a water-repelling powder in a case that a water-base ink is used) can be also used as the powder 3. A part or portion of the powder 3 supplied to the transporting roller 4 moves to the recording surface of the recording medium 1. By providing the powder, in a case that the sheets of the recording medium are stacked after the recording has been completed, it is possible to effectively prevent the transfer of image to the following recording medium (the so-called back transfer) and sticking of the sheets of recording medium to each other.

Examples of the lyophilic powder (hydrophilic powder) suitable as the powder 3 include acrylic particles, divinylbenzene polymer particles, glass particles, polystyrene particles, polymethyl methacrylate particles polypropylene particles, styrene-acryl copolymer particles, edible starch, wheat flour, etc.; examples of the powder having high ability to absorb liquids (powder having high ability to absorb water) include fine particles of water absorbing polymer, etc.; examples of porous particle include inorganic oxides such as talc, silica gel, alumina (aluminium oxide), titanium oxide, zinc oxide, etc.; and examples of the liquid-repelling powder (water-repelling powder) include fine particles of fluoropolymer, etc. The powder 3 of one kind may be used, or the powders of two or more kinds may be used together.

The average particle size of the powder 3 is preferably not less than 10 μm, more preferably not less than 15 μm, even more preferably 15 μm to 50 μm, and even more preferably 18 μm to 50 μm. In a case that the average particle size is not less than 10 μm, the contact surface area of the recording medium 1 and transporting roller 4 is effectively reduced. In a case that the average particle size is not more than 50 μm, the powder 3 easily adheres to the transporting roller 4 and contact tracks of the powder 3 hardly remain on the recording medium 1. Examples of the average particle size include a number-average particle size, a weight-average particle size, and a volume-average particle size. For example average particle size can be represented by a mesh size of a test sieve measured by a sieving method, a Stokes equivalent diameter determined by a precipitation method, an equivalent circle diameter determined by microscopy, a sphere equivalent value determined by a light scattering method, and a sphere equivalent value determined by an electric resistance test method (Coulter counter). In the present embodiment, the powder was observed by using a microscope under a magnification of 50-500, a scale was used to measure the particle size of each of 100 pieces of the particles, and the average particle size was calculated.

It is preferred that the powder supply blade 6 be pressed against the surface of the transporting roller 4 before the powder is supplied, but the powder supply blade may be also separated from the transporting roller, provided that the powder 3 can movably adhere to the surface of the transporting roller 4. For example, the powder supply blade 6 and the surface of the transporting roller 4 may be separated by a distance which is substantially equal to the average particle size of the powder 3 or by a distance which is slightly smaller than the average particle size. The pressing force acting between the powder supply blade 6 and the surface of the transporting roller 4 in a case that the powder supply blade 6 and the surface of the transporting roller 4 are pressed against each other is not particularly limited provided that the powder 3 can movably adhere to the surface of the transporting roller 4. As will be described below in the sixth embodiment, the distance between the surface of the powder supply blade 6 and the surface of the transporting roller 4 may be appropriately adjusted based on the type of the powder, the type of the recording medium 1, the type of the ink, etc.

The amount of the powder 3 that adheres to the surface of the transporting roller 4 is not particularly limited. It is preferred that the powder 3 adheres to the entire surface of the transporting roller 4, but the present embodiment is not limited to this, and it is allowable that the powder 3 does not adhere to part of the surface of the transporting roller 4, provided that the recording medium 1 can be transported in a state that the powder 3 is intervened or interposed between the recording surface of the recording medium 1 and the surface of the transporting roller 4. Note that as will be described below in the sixth embodiment, the amount of the powder 3 adhering to the surface of the transporting roller 4 may be appropriately adjusted based on the type of the powder, the type of the recording medium 1, the type of the ink, etc.

### Ink Jet Recording Method

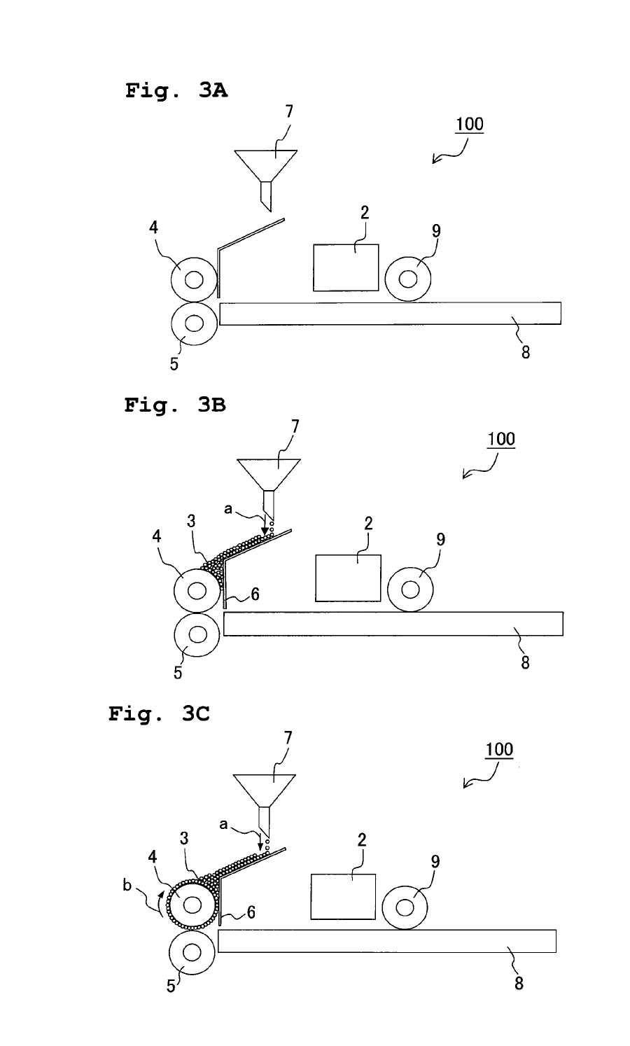

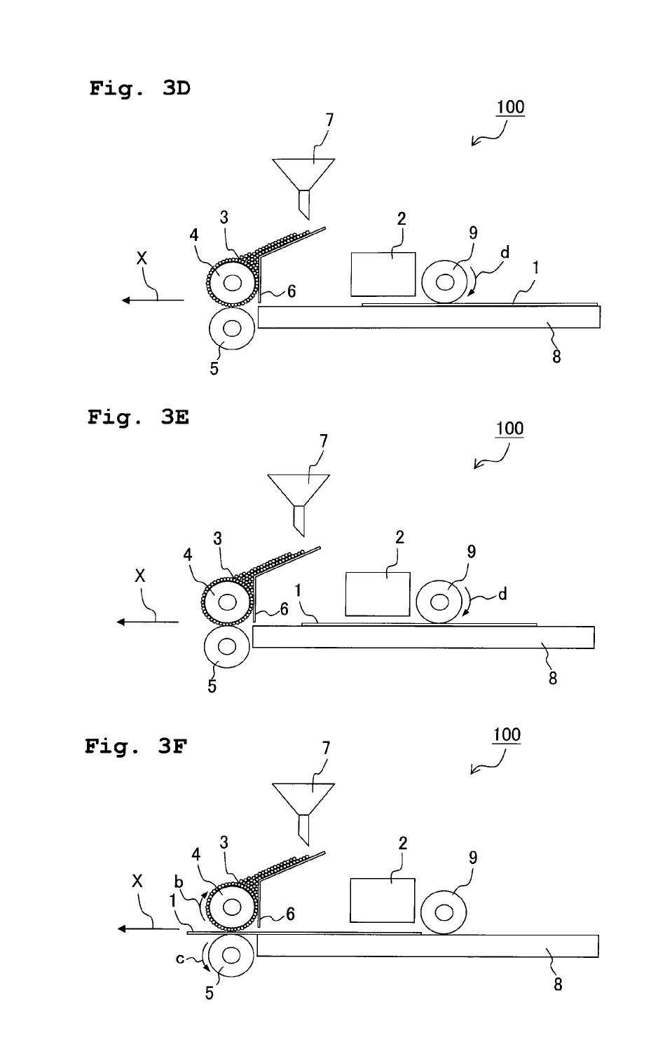

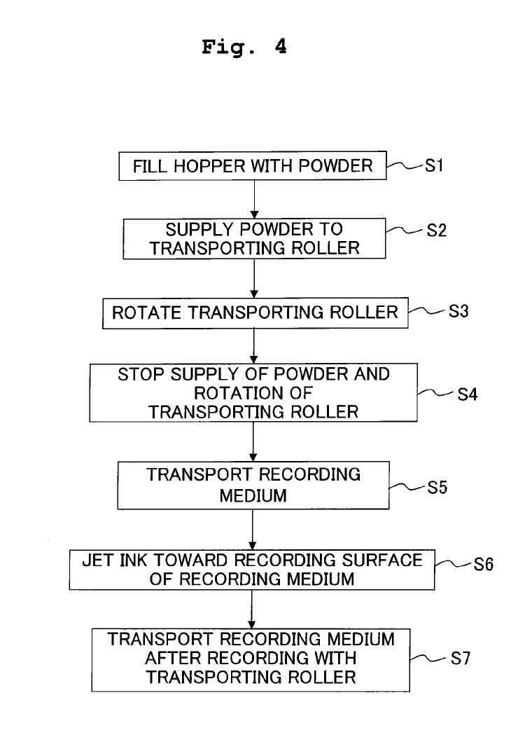

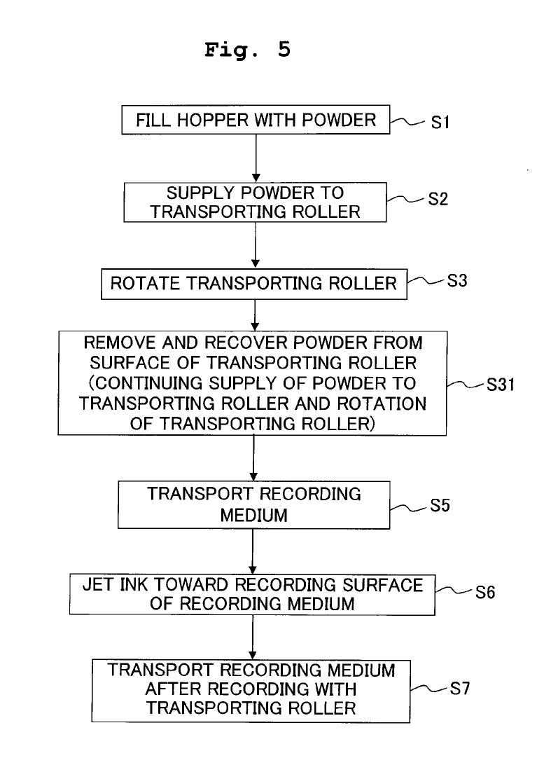

The ink jet recording method using the ink jet recording apparatus 100 will be explained below with reference to FIGS. 3 and 4. First, as a preparation for recoding, the hopper 7 is filled with the powder 3 (FIG. 3A, step S1).

Then, as shown in FIG. 3B, the powder 3 is supplied from the hopper 7 to the right upper portion of the transporting roller 4 via the powder supply blade 6 (step S2).

Then, as shown in FIG. 3C, the transporting roller 4 is rotated as shown by the arrow “b”, thereby causing the powder 3 to movably adhere to the surface of the transporting roller 4 (step S3).

Then, as shown in FIG. 3D, the supply of the powder 3 from the hopper 7 and the rotation of the transporting roller 4 are stopped (step S4). The recording medium 1 which has been fed from the paper feed section (not shown in the figure) to the side of the recording medium transporting guide 8 is transported at a position below or under the paper feed roller 9. Here, the paper feed roller 9 is then rotated as shown by the arrow “d”, thereby transporting the recording medium 1 to be below the ink jet head 2 (step S5).

Then, as shown in FIG. 3E, when the recording medium 1 passes below the ink jet head 2, the ink is jetted toward the recording surface of the recording medium 1. As a result, an image is recorded on the recording surface of the recording medium 1 (step S6).

Then, as shown in FIG. 3F, the recording medium 1 on which the image has been recorded is guided by the recording medium transporting guide 8 and is transported between the transporting roller 4 and the nip roller 5. Then, by rotating the transporting roller 4 and the nip roller 5 in the opposite directions, as shown by the arrows “b” and “c”, the recording medium 1 after recording is transported in a state that the powder 3 is intervened between the recording surface of the recording medium 1 and the surface of the transporting roller 4 (step S7). At this time, a part of the powder 3 supplied to the transporting roller 4 moves to the recording surface of the recording medium 1.

In the ink jet recording apparatus and ink jet recording method of the present embodiment, the powder 3 is caused to adhere in the movable state to the surface of the transporting roller 4, thereby making it possible to transport the recording medium after recording in a state that the powder 3 is intervened between the recording surface of the recording medium 1 and the surface of the transporting roller 4. Because the powder 3 moves freely by rotation or the like over the surface of the transporting roller 4, when the transporting roller transports the following recording medium, a portion of the surface of the powder 3, the portion being is different from another portion of the powder 3 which has come into contact with the surface of the previous recording medium (the another portion of the surface of the powder 3 which might be dirtied or stained) comes into contact with the recording surface of the following recording medium. This inhibits the image transfer from the recording surface of the recording medium 1 to the transporting roller 4 and the retransfer of the image from the transporting roller 4 to the recording surface of the following recording medium 1, and enhances the recording quality.

According to the ink jet recording apparatus and ink jet recording method of the present embodiment, for example even in a case that a water-base pigment ink with a low drying speed is used and even in a case of high-speed recording using the line-type ink jet head as the ink jetting mechanism, it is possible to advantageously prevent or suppress the image transfer from the recording surface of the recording medium 1 to the transporting roller 4 and the retransfer of the image from the transporting roller 4 to the recording surface of the following recording medium 1, and to provide excellent recording quality.

Further, in the present embodiment, when the recording medium 1 is transported by the transporting roller 4, a part of the powder 3 supplied to the transporting roller 4 moves to the recording surface of the recording medium 1. Since the following recording medium is stacked on the recording surface to which the powder 3 has adhered, the powder 3 is intervened between the two sheets of recording medium. As a result, it is possible to prevent the image transfer to the following recording medium (the so-called back transfer) and the sticking of the two sheets of recording medium together.

### Second Embodiment

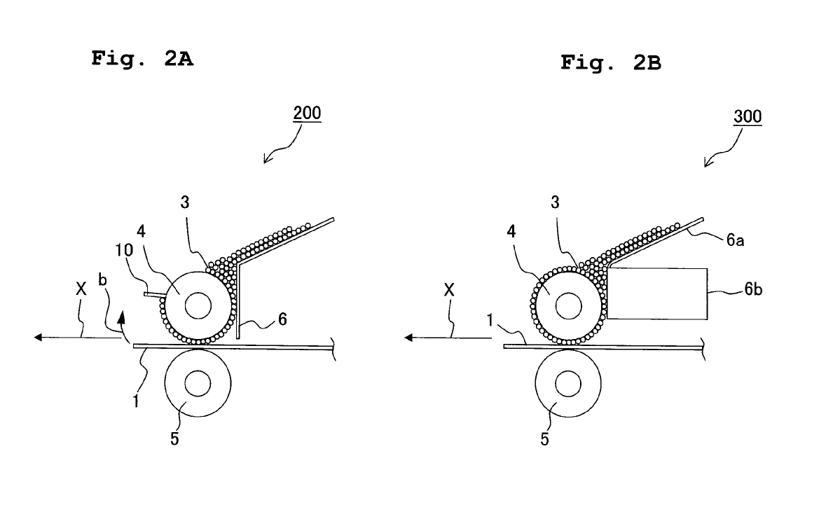

This embodiment is an example provided with a mechanism which recovers, from the transporting roller 4, the powder 3 adhered to the transporting roller 4. As shown in FIG. 2A, an ink jet recording apparatus 200 of the present embodiment is provided with a powder removal blade 10. The powder removal blade 10 is disposed downstream, in the recording medium transporting direction X (left side in FIG. 2A), of a contact point at which the recording surface of the recording medium 1 and the transporting roller 4 come into contact, and the powder removal blade 6 comes into contact with the transporting roller so as not to hinder or prevent the rotation of the transporting roller 4. The powder removal blade 10 is attached, for example, to a rotary support shaft of the transporting roller 4 or a body of the ink jet recording apparatus 200. Other than above, the remaining constructive features of the ink jet recording apparatus 200 of the second embodiment are similar to those of the ink jet recording apparatus 100 of the first embodiment.

The ink jet recording method of the present embodiment will be described below with reference to FIG. 5. In the second embodiment, steps Si to S3 are executed or implemented in the same manner as in the first embodiment, and after the powder 3 is made to adhered in the movable state to the surface of the transporting roller 4 (step S3), the powder 3 is removed from the surface of the transporting roller 4 by the powder removal blade 10 (step S31). Specifically, the transporting roller 4 is continuously rotated in the direction shown by arrow “b”, and the powder 3 adhering to the surface of the transporting roller 4 is brought into contact with the powder removal blade 10 and is thereby scraped off from the surface of the transporting roller 4. The removed powder 3 is recovered, for example, in a powder recovery container (not shown in the figure) provided in the vicinity of the powder removal blade 10.

In the first embodiment, after the powder 3 is made to adhere in the movable state to the surface of the transporting roller 4 (step S3), the supply of the powder 3 from the hopper 7 and the rotation of the transporting roller 4 are stopped (step S4), but in the second embodiment, the supply of the powder 3 from the hopper 7 and the rotation of the transporting roller 4 are continued without being stopped (step S4 is not implemented). Therefore, the new powder is always supplied to the transporting roller 4 in parallel with the process of removing the powder 3 from the surface of the transporting roller 4 with the powder removal blade 10.

Then, similarly to the first embodiment, the recording medium 1, which is fed from a paper feeder (not shown in the figure) to the recording medium transporting guide 8, is transported to a position below the paper feed roller 9 (step S5); the ink is jetted toward the recording surface of the recording medium 1 to record an image (step S6); then the transporting roller 4 and nip roller 5 are rotated to transport the recording medium 1 in a state that the powder 3 is intervened between the recording surface of the recording medium 1 and the surface of the transporting roller 4 (step S7).

In the present embodiment, the powder 3 that has once come into contact with the recording medium 1 is removed from the transporting roller 4 by the powder removal blade 10, and the new powder 3 is supplied to the transporting roller 4 at all times. Therefore, the powder 3 which comes into contact with the recording medium 1 is a new powder at all times. As a result, the retransfer of image from the transporting roller 4 to the recording surface of the following recording medium 1 is inhibited and recording quality is improved.

### Third Embodiment

The present embodiment is an example in which a powder supply mechanism is different from that of the first embodiment. As shown in FIG. 2B, in an ink jet recording apparatus 300 of the present embodiment, a powder supply guide plate 6a and a sponge 6b are provided as the powder supply mechanism, instead of the powder supply blade 6. The powder supply guide plate 6a is inclined at a portion of the powder supply guide plate 6a below the hopper 7, toward the downstream side (left side in FIG. 2B) in the recording medium transporting direction X. The sponge 6b is disposed in the vicinity of the upstream side (right side in FIG. 2B), in the recording medium transporting direction X, of the transporting roller 4. Other than above, the remaining constructive features of the ink jet recording apparatus 300 of the third embodiment are similar to those of the ink jet recording apparatus 100 of the first embodiment.

The ink jet recording method of the present embodiment is implemented similarly to that of the first embodiment illustrated by FIG. 4. Since the sponge 6b of the present embodiment has excellent flexibility, the powder can be caused to adhere easily and uniformly to the surface of the transporting roller 4, even without accurate control of the distance to the transporting roller 4. Further, even if the sponge is pressed against the transporting roller 4, the surface of the transporting roller 4 is not damaged.

### Fourth Embodiment

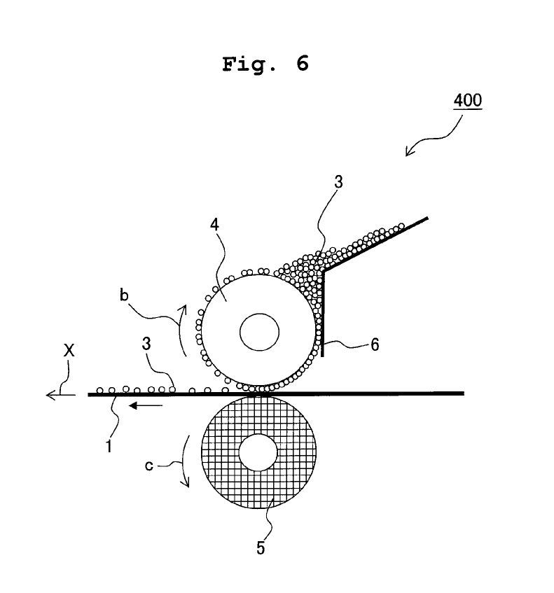

The present embodiment is an example in which the powder 3 supplied to the transporting roller 4 is actively moved to the recording medium 1. As shown in FIG. 6, an ink jet recording apparatus 400 of the present embodiment is further provided with a voltage application mechanism (not shown in the figure) which is capable of applying a voltage to the transporting roller 4 or nip roller 5. Further, the nip roller 5 has, on the surface thereof, an electrically conductive substance which can be electrically charged by the voltage applied with the voltage application mechanism. Examples of such a construction of the nip roller include a rubber added with electro-conductive carbon, etc. Further, a chargeable powder is used as the powder 3. Examples of the chargeable powder include acrylic polymer particles, divinylbenzene polymer particles, polystyrene particles, polymethyl methacrylate particles, polypropylene particles, styrene-acryl copolymer particles, etc., but a charge control agent such as azine compound, quaternary ammonium salt, azo-containing metal compound, salicylic acid compound, styrene-acryl copolymer, etc. may be also added. A well-known method that is generally used, for example, in laser printers, etc. can be used to apply a voltage to the rollers. Other than above, the remaining constructive features of the ink jet recording apparatus 400 are similar to those of the ink jet recording apparatus 100 of the first embodiment.

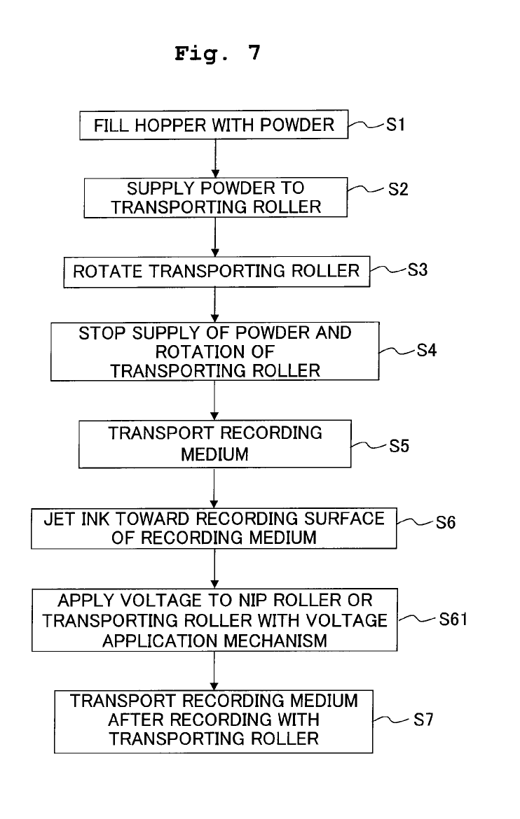

The ink jet recording method of the present embodiment will be explained with reference to FIGS. 6 and 7. Similarly to the first embodiment, the hopper 7 is filled with the powder 3 (step S1). Then, the powder 3 is supplied to the transporting roller 4 via the powder supply blade 6 (step S2); and the powder 3 is caused to adhere in the movable state to the surface of the transporting roller 4 (step S3). In the fourth embodiment, when the powder 3 is supplied to the transporting roller 4 (step S2), the powder 3 is electrically charged by friction with the powder supply blade 6, and the electrically charged powder 3 is supplied to the transporting roller 4. In the fourth embodiment, the powder 3 is charged negatively.

Further, similarly to the first embodiment, the supply of the powder 3 and the rotation of the transporting roller 4 are stopped (step S4), the recording medium 1 is transported to a position below the ink jet head 2 (step S5), and the ink is jetted toward the recording surface of the recording medium 1 (step S6).

Then, the recording medium 1 on which an image has been recorded is transported along the recording medium transporting guide 8, to be between the transporting roller 4 and the nip roller 5. At this time, a voltage of a polarity different from that of the powder 3 is applied to the nip roller 5 by the voltage application mechanism (step S61). In the fourth embodiment, since the powder 3 is charged negatively, a positive voltage is applied to the nip roller 5. Then, by rotating the transporting roller 4 and nip roller 5 in the opposite directions as shown by arrows “b” and “c”, the recording medium 1 on which an image has been recorded is transported in a state that the powder 3 is intervened between the recording surface of the recording medium 1 and the surface of the transporting roller 4 (step S7). The negatively charged powder 3 is attracted to the nip roller 5 charged by a positive voltage, thereby causing the powder to adhere to the recording medium 1.

In the fourth embodiment, the powder 1 is actively applied to the recording surface of the recording medium 1, thereby effectively preventing the back transfer to the following recording medium and also preventing the sheets of recording medium after recording from sticking together.

### Fifth Embodiment

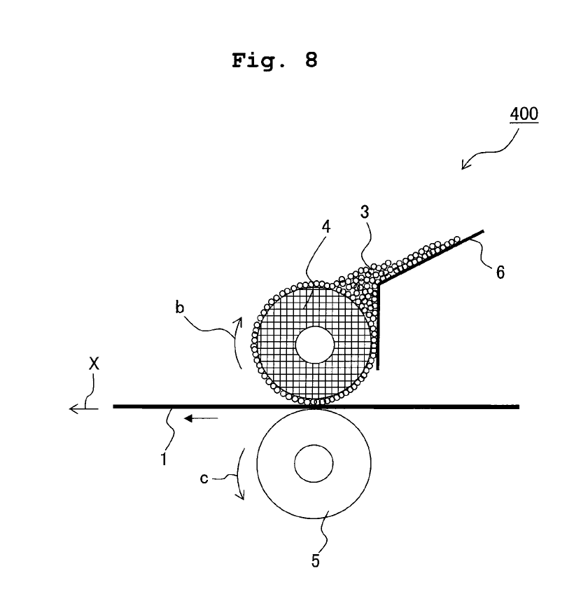

The present embodiment is an example in which the powder 3 that adhered to the transporting roller 4 is prevented or inhibited from moving to the recording medium 3. Similarly to the ink jet recording apparatus used in the fourth embodiment, an ink jet recording apparatus 400 of the fifth embodiment shown in FIG. 8 is provided with a voltage application mechanism (not shown in the figure) which is capable of applying a voltage to the transporting roller 4 or nip roller 5. Further, similarly to the fourth embodiment, an electrically chargeable powder is used as the powder 3.

The ink jet recording method of the fifth embodiment will be explained below with reference to FIGS. 7 and 8. The fifth embodiment is implemented similarly to the fourth embodiment, except that a voltage of a polarity different from that of the powder 3 is applied to transporting roller 4 by the voltage application mechanism in step S61. In the fifth embodiment, since the powder 3 is charged negatively, a positive voltage is applied to the transporting roller 4. Similarly to the fourth embodiment, the transporting roller 4 and nip roller 5 are rotated in the opposite directions as shown by arrows “b” and “c”, thereby transporting the recording medium 1 on which an image has been recorded in a state in which the powder 3 is intervened between the recording surface of the recording medium 1 and the surface of the transporting roller 4 (step S7). The negatively charged powder 3 is held on the surface of the transporting roller 4 charged by a positive voltage, and the powder is thereby prevented from adhering to the surface of the recording medium 1.

Depending on the application of the printed matter, this is a possibility that the user does not wish the adhesion of the powder to the recording medium, or that in some cases the recording medium has a sufficiently fast drying ability and the application of the powder to the recording surface is unnecessary. In the fifth embodiment, in response to such needs, the powder 3 can be prevented from adhering to the recording medium 1.

### Sixth Embodiment

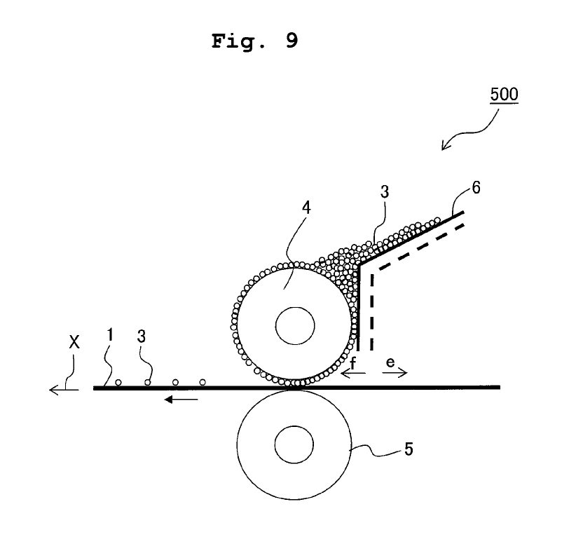

The present embodiment is an example in which the amount (adhering amount) of the powder 3 adhered to the transporting roller 4 is controlled. As shown in FIG. 9, an ink jet recording apparatus 500 of the present embodiment is provided with an actuator (not shown in the figure) which moves the powder supply blade 6 in order to control the distance (gap width) between the powder supply blade 6 and the transporting roller 4. A well-known actuator such as a piezoelectric actuator can be used as the actuator. The actuator widens the gap by moving the powder supply blade 6 in a direction of arrow “e” shown in FIG. 9; and contrary to this, narrows the gap by moving the powder removal blade 10 in a direction of arrow “f′. Other than above, the remaining constructive features of the ink jet recording apparatus 500 of the sixth embodiment are similar to those of the ink jet recording apparatus 100 of the first embodiment.

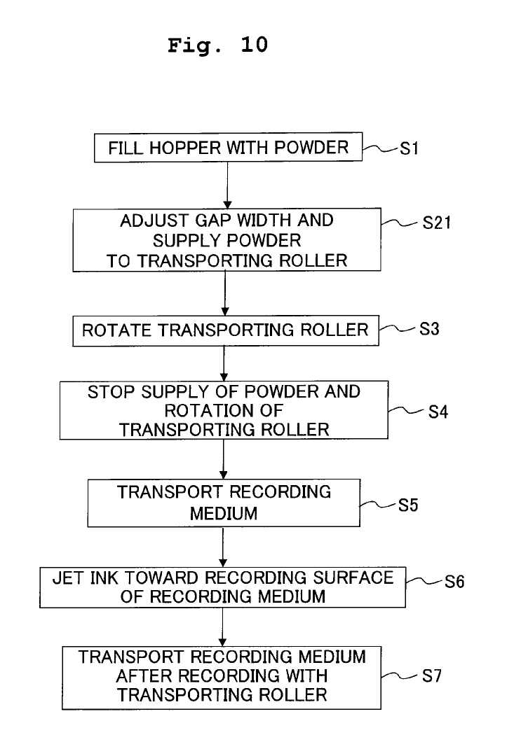

The ink jet recording method of the present embodiment will be explained below with reference to FIGS. 9 and 10. The ink jet recording method of the sixth embodiment is implemented similarly to the first embodiment, except that the powder 3 is supplied by moving the powder supply blade 6 with the actuator and adjusting the gap width (step S21) in the step of supplying the powder 3 to the transporting roller 4. For example, in a case that the recording medium 1 has poor drying ability, the powder removal blade 10 is moved in the direction of arrow “e” shown in FIG. 9 so as to widen the gap, thereby increasing the amount of the powder 3 adhering to the transporting roller 4.

By increasing the amount of the powder 3 adhering to the transporting roller, the image transfer from the recording surface of the recording medium 1 to the transporting roller 4 and the image retransfer from the transporting roller 4 to the recording surface of the following recording medium 1 are inhibited and recording quality is increased. At the same time, the amount of the powder 3 moving from the transporting roller 4 to the recording medium 1 is also increases, and the back transfer to the following recording medium and the sticking of the recording medium sheets to each other after recording can be effectively prevented.

### Seventh Embodiment

The present embodiment is an example in which porous particles are used for the powder 3. The ink jet recording apparatus of the seventh embodiment is similar to the ink jet recording apparatus 100 of the first embodiment shown in FIG. 1, except that porous particles are used for the powder 3. The ink jet recording method of the seventh embodiment is implemented similarly to the ink jet recording method of the first embodiment shown in FIG. 4. Colorless silica gel and alumina can be used as porous particles.

In the seventh embodiment, the usage of porous particles as the powder 3 increases the ink absorption ability of the powder 3. As a result, it is possible to effectively prevent the image transfer from the recording surface of the recording medium 1 to the transporting roller 4 and the image retransfer from the transporting roller 4 to the recording surface of the following recording medium 1, thereby increasing the recording quality. Further, it is possible to effectively prevent the back transfer to the following recording medium and the sticking of the recording medium sheets to each other after recording.

### Eighth Embodiment

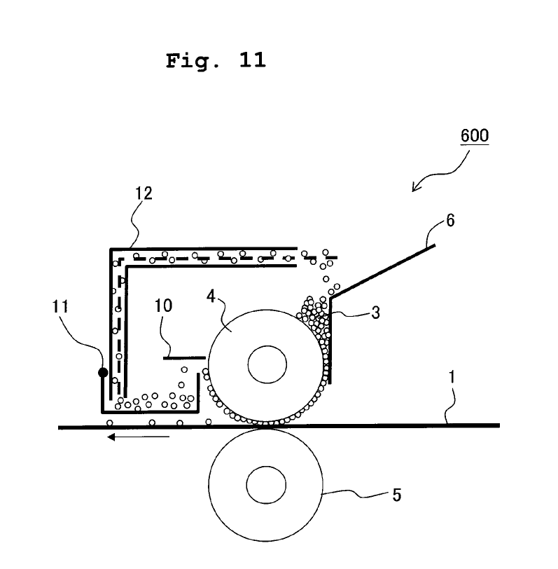

The present embodiment is an example provided with a recycle system for the powder 3 which recovers the powder 3 adhered to the transporting roller 4 from the transporting roller 4 and which supplies the recovered power 3 again to the transporting roller 4. As shown in FIG. 11, an ink jet recording apparatus 600 of the eighth embodiment is provided with a powder removal blade 10, a powder recovery container 11, and a powder transport mechanism 12. The powder removal blade 10 has a construction similar to that of the second embodiment. The powder recovery container 11 is disposed adjacently to a position below the powder removal blade 10 so that the powder 3 recovered from the transporting roller 4 by the powder removal blade 10 can be accommodated in the powder recovery container. The powder transport mechanism 12 is disposed so as to connect or link the powder recovery container 11 to the powder supply blade 6 and to transport the powder 3 accommodated in the powder recovery container 11 to the powder supply blade 6 which serves as the powder supply mechanism. A pipe having a transport spring accommodated therein is used as the powder transport mechanism 12. By rotating the internal transport spring, it is possible to transport the powder 3 accommodated in the powder recovery container 11 to the powder supply blade 6 along the spring. Other well-known powder transport mechanism can be also used as the powder transport mechanism 12. Other than above, the remaining constructive features of the ink jet recording apparatus 600 of the eighth embodiment are similar to those of the ink jet recording apparatus 100 of the first embodiment.

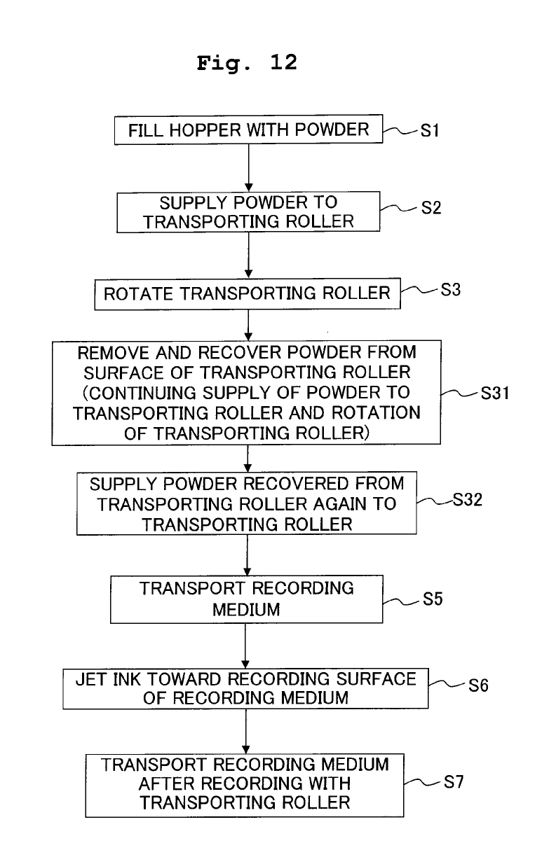

The ink jet recording method of the present embodiment will be explained below with reference to FIG. 12. In the eighth embodiment, steps S1 to S31 are implemented in the same manner as in the second embodiment; the powder 3 is removed from the surface of the transporting roller 4 by the powder removal blade 10 (step S31); and the removed powder 3 is accommodated in the powder recovery container 11.

Then, the powder transport mechanism 12 transports the powder accommodated in the powder recovery container 11 to the powder supply blade 6 and the recovered powder 3 is supplied again to the transport roller 4 (step S32). In such a manner, the powder 3 is thus circulates among the powder supply blade 6, transporting roller 4, powder removal blade 10, powder recovery container 11, and powder transport mechanism 12.

Then, similarly to the first embodiment, the recording medium 1 fed from the paper feeder (not shown in the figure) to the recording medium transport guide 8 is transported to a position below the paper feed roller 9 (step S5); the ink is jetted toward the recording surface of the recording medium 1 to perform recording of an image (S6). Then, the transporting roller 4 and nip roller 5 are rotated and the recording medium 1 is transported in a state that the powder 3 is intervened between the recording surface of the recording medium and the surface of the transporting roller 4 (step S7).

In the present embodiment, the powder 3 recovered from the transporting roller 4 is circulated, to be reused by being adhered again to the transporting roller 4. Therefore, the running cost of ink jet recording can be reduced by comparison with a case that the new powder 3 is supplied at all times, as in the second embodiment. Further, since the powder 3 is circulated, the amount of powder 3 that is moved and rotated at the surface of the transporting roller 4 can be increased. As a result, when the transporting roller again transports the following recording medium, the probability is increased that a portion of the surface of the powder 3, the portion being different from another portion of the surface of the powder 3 which come into contact with the previous recording medium (another portion having possibility of being dirtied or stained), comes into contact with the recording surface of the following recording medium. The eighth embodiment effectively suppresses the image transfer from the recording surface of the recording medium 1 to the transporting roller 4 and the image retransfer from the transporting roller 4 to the recording surface of the following recording medium 1.

In the eighth embodiment, the powder 3 may be discarded after being recycled for a predetermined period of time. For example, it is allowable that the number of printed sheets of the recording medium 1, printing time, ink jetting amount, etc. is/are measured; and that when the predetermined values that have been set in advance are reached, the recovered powder 3 may be discarded and the new powder 3 may be supplied to the transporting roller 4.

In the above-described first to eighth embodiments, the implementation order of steps in the ink jet recording methods can be changed or a part of the steps may be omitted, if necessary. For example, in the first embodiment, an example is described in which the transporting of the recording medium 1 is started (step S3) after the powder 3 has been supplied to the transporting roller 4 (step S2), but the present invention is not limited to this, and it is allowable to start the supply of the powder 3 to the transporting roller 4 and the transportation of the recording medium 1 at the same time or to start the transportation of the recording medium 1 earlier, provided that the recording medium 1 after recording can be transported in a state that the powder 3 is intervened between the recording surface of the recording medium 1 and the surface of the transporting roller 4.

### Examples

Examples of the present invention will be explained below together with comparative examples. The present invention is not limited to the below-described examples and comparative examples.

### Preparation of Water-Base Ink for Ink Jet Recording

### (a) Ink 1 (Black Ink)

Components of the ink composition (Table 1), other than a self-dispersible pigment “CAB-O-JET (trade name) 300”, were uniformly mixed to obtain an ink solvent. The self-dispersible pigment was then gradually added to the ink solvent, followed by being mixed uniformly. The mixture thus obtained was then filtrated or filtered through a cellulose acetate membrane filter (pore size 3.00 μm) manufactured by Toyo Roshi Kaisha Ltd. to obtain Ink 1.

### (b) Ink 2 (Black Ink)

Carbon black “MA100” 15 wt %, “DISPERBYK 190” 9 wt %, glycerin 15 wt %, and water 61 wt % were mixed, then dispersion treatment was performed in a wet sand mill using zirconia beads with a diameter of 0.3 mm as a medium to obtain a black pigment dispersion. Then, water 55.4 wt %, glycerin 40.5 wt %, dipropylene glycol n-propyl ether 3 wt %, and “Orfin (trade name) E1010” 1.1 wt % were mixed to obtain an ink solvent. The ink solvent 66.7 wt % was then gradually added to the black pigment dispersion 33.3 wt % under stirring and the components were uniformly mixed. The mixture thus obtained was then filtrated through a cellulose acetate membrane filter (pore size 3.00 μm) manufactured by Toyo Roshi Kaisha Ltd. to obtain Ink 2. The ink composition of the Ink 2 is shown in Table 1.

### (c) Ink 3 (Magenta Ink)

The components of the ink composition (Table 1), other than a self-dispersible pigment “CAB-O-JET (trade name) 260M” were uniformly mixed to obtain an ink solvent. The self-dispersible pigment was then gradually added to the ink solvent, followed being uniformly mixed. The mixture thus obtained was then filtrated through a cellulose acetate membrane filter (pore size 3.00 μm) manufactured by Toyo Roshi Kaisha Ltd. to obtain Ink 3.

TABLE 1

| | Ink 1 | Ink 2 | In 3 |
|---|---|---|---|
| | Black ink | Black ink | Magenta ink |
| CAB-O-JET (trade name) 300 (*1) | 40.0 | — | — |
| MA100 (*2) | — | 5.0 | — |
| CAB-O-JET (trade name) | — | — | 50.0 |
| 260M (*3) | | | |
| Glycerin | 33.15 | 32.0 | 34.0 |
| Dipropylene glycol | 5.0 | — | 5.0 |
| Dipropylene glycol n-propyl ether | 2.0 | 2.0 | 2.0 |
| Orfin (trade name) E1010 (*4) | 0.7 | 0.7 | 0.7 |
| Sannole (trade name) NL1430 (*5) | 1.2 | — | 1.2 |
| DISPERBYK 190 (*6) | — | 3.0 | — |
| Water | Balance | Balance | Balance |

Ink composition units: wt %
(*1): self-dispersible pigment: pigment concentration = 15 wt %, manufactured by Cabot Specialty Chemicals Co., Ltd.
(*2): Carbon black: manufactured by Mitsubishi Chemical Corp.
(*3): self-dispersible pigment: pigment concentration = 10 wt %, manufactured by Cabot Specialty Chemicals Co., Ltd.
(4*): Acetylene glycol surfactant (ethylene oxide (10 mol) adduct of acetylene diol); effective component amount = 100 wt %; manufactured by Nisshin Kagaku Kogyo KK.
(*5): Polyoxyethylene (3E.O.) alkyl (C = 12 = 13) ether sulfuric acid sodium; effective component amount = 28 wt %; manufactured by Lion Corp.
(*6): Manufactured by Byk-Chemi Co.

### Example 1

An image was recorded on the recording surface of a recording medium 1 (LaserPrint 241b, manufactured by Hammennill) according to the recording method shown in FIG. 4 by using the ink jet recording apparatus 100 shown in FIG. 1. The image was recorded by using the Ink 1 on a central portion located 44 mm downstream of the leading end of the recording medium 1 in the recording medium transporting direction X, under the following conditions: recording surface area: 22 mm (length)×22 mm (width), recording density: 100%. The shape, size, and operation conditions of the structural components of the ink jet recording apparatus 100 are described below.

### Shape, Size, and Operation Conditions of Structural Components

Ink jet head 2: the water-base ink of 21 pL per 1 dot was jetted at 600 dpi.

Powder 3: acrylic particles (particle size 18 μm, manufactured by Toyobo Co., Ltd.; TAFTIC (trade name) AR650S).

Transporting roller 4: a roller with a diameter of 13 mm in which a rubber cylinder is molded around a metal core and convex portions and concave portions are provided on the surface to cause the adhesion of the powder 3. The revolution speed=1390 rpm.

Nip roller 5: a roller with a diameter of 13 mm in which a rubber cylinder is molded around a metal core. The revolution speed=1390 rpm.

Contact pressure force between the transporting roller 4 and nip roller 5: 0.18 kgf/cm² (0.18×9.8×10⁴ Pa).

Paper feed roller 9: a roller with a diameter of 13 mm in which a rubber cylinder is molded around a metal core. The revolution speed=1390 rpm.

### Example 2

An image was recorded in the same manner as in Example 1, except that divinylbenzene polymer particles (particle size 30 μm; manufactured by Sekisui Chemical Co., Ltd.; MICROPEARL (trade name) GS-230) was used as the powder 3.

### Example 3

An image was recorded in the same manner as in Example 1, except that glass particles (particle size 30 μm; manufactured by the Association of Powder Process Industry and Engineering, Japan; Glass Beads GBL-30) was used as the powder 3.

### Example 4

An image was recorded in the same manner as in Example 1, except that polystyrene particles (particle size 50 μm; manufactured by Ganz Chemical Co., Ltd.; GANZ PEARL (trade name) GM-5003) were used as the powder 3.

### Example 5

An image was recorded in the same manner as in Example 1, except that the Ink 2 was used instead of the Ink 1.

### Example 6

An image was recorded in the same manner as in Example 2, except that the Ink 2 was used instead of the Ink 1.

### Example 7

An image was recorded in the same manner as in Example 3, except that the Ink 2 was used instead of the Ink 1.

### Example 8

An image was recorded in the same manner as in Example 4, except that the Ink 2 was used instead of the Ink 1.

### Example 9

An image was recorded in the same manner as in Example 1, except that the Ink 3 was used instead of the Ink 1.

### Example 10

An image was recorded in the same manner as in Example 2, except that the Ink 3 was used instead of the Ink 1.

### Example 11

An image was recorded in the same manner as in Example 3, except that the Ink 3 was used instead of the Ink 1.

### Example 12

An image was recorded in the same manner as in Example 4, except that the Ink 3 was used instead of the Ink 1.

### Example 13

An image was recorded in the same manner as in Example 1, except that acrylic particles (particle size 3 μm, manufactured by JSR Co., SX8703(A)-02) were used as the powder 3.

### Example 14

An image was recorded in the same manner as in Example 1, except that divinylbenzene polymer particles (particle size 10 μm; manufactured by Sekisui Chemical Co., Ltd.; MICROPEARL (trade name) SP-210) were used as the powder 3.

### Example 15

An image was recorded in the same manner as in Example 5, except that acrylic particles (particle size 3 μm, manufactured by JSR Co., SX8703(A)-02) were used as the powder 3.

### Example 16

An image was recorded in the same manner as in Example 5, except that divinylbenzene polymer particles (particle size 10 μm; manufactured by Sekisui Chemical Co., Ltd.; MICROPEARL (trade name) SP-210) were used as the powder 3.

### Example 17

An image was recorded in the same manner as in Example 9, except that acrylic particles (particle size 3 μm, manufactured by JSR Co., SX8703(A)-02) were used as the powder 3.

### Example 18

An image was recorded in the same manner as in Example 9, except that divinylbenzene polymer particles (particle size 10 μm; manufactured by Sekisui Chemical Co., Ltd.; MICROPEARL (trade name) SP-210) were used as the powder 3.

### Example 19

An image was recorded in the same manner as in Example 1, except that wheat flour (particle size: 15 μm) was used as the powder 3.

### Example 20

An image was recorded in the same manner as in Example 1, except that edible starch (particle size: 30 μm) was used as the powder 3.

### Example 21

An image was recorded in the same manner as in Example 1, except that a baby powder (talc) (particle size: 10 μm) was used as the powder 3.

### Comparative Example 1

An image was recorded in the same manner as in Example 1, except that the powder 3 was not used.

### Comparative Example 2

An image was recorded in the same manner as in Example 5, except that the powder 3 was not used.

### Comparative Example 3

An image was recorded in the same manner as in Example 9, except that the powder 3 was not used.

The transfer evaluation was performed by the following method with respect to the examples and comparative examples.

### Transfer Evaluation

Image recording on the recording surface of the recording medium 1 was continuously performed on two sheets. Traces (retransfer traces) produced by the retransfer of the image of the first sheet of the recording medium 1 onto the recording surface of the second sheet of recording medium 1 via the transporting roller 4 were visually evaluated. The evaluation criteria are presented below.

### Transfer Evaluation and Evaluation Criteria

A: there were no retransfer traces.

B: the number of retransfer traces was not more than 3.

C: the number of retransfer traces was not less than 4; the contour of the retransferred image was unclear.

D: the number of retransfer traces was not less than 4 and less than 10; the contour of the retransferred image was clear.

E: the number of retransfer traces was not less than 10; there was significant dirtying (staining) by retransferred image; the print was not suitable for practical use.

The types and particle sizes of the powders 3, ink types, and evaluation results obtained in the retransfer evaluation for the examples and comparative examples are shown in Table 2.

TABLE 2

| | Water-insoluble powder | | | |
|---|---|---|---|---|
| | | Particle size | | Transfer evaluation |
| | Type | (μm) | Ink | results |
| Example 1 | Acrylic particles | 18 | Ink 1 | A |
| | (manufactured by Toyobo Co., | | | |
| | Ltd.; TAFTIC (trade name | | | |
| | AR650S) | | | |
| Example 2 | Divinylbenzene polymer particles | 30 | Ink 1 | A |
| | (manufactured by Sekisui | | | |
| | Chemical Co., Ltd.; | | | |
| | MICROPEARL (trade name) GS- | | | |
| | 230) | | | |
| Example 3 | Glass particles | 30 | Ink 1 | A |
| | (manufactured by the Association | | | |
| | of Powder Process Industry and | | | |
| | Engineering, Japan; Glass Beads | | | |
| | GBL-30) | | | |
| Example 4 | Polystyrene particles | 50 | Ink 1 | A |
| | (manufactured by Ganz Chemical | | | |
| | Co., Ltd.; GANZ PEARL (trade | | | |
| | name) GM-5003) | | | |
| Example 5 | Acrylic particles | 18 | Ink 2 | A |
| | (manufactured by Toyobo Co., | | | |
| | Ltd.; TAFTIC (trade name) | | | |
| | AR650S) | | | |
| Example 6 | Divinylbenzene polymer particles | 30 | Ink 2 | A |
| | (manufactured by Sekisui | | | |
| | Chemical Co., Ltd.; | | | |
| | MICROPEARL (trade name) GS- | | | |
| | 230) | | | |
| Example 7 | Glass particles | 30 | Ink 2 | A |
| | (manufactured by the Association | | | |
| | of Powder Process Industry and | | | |
| | Engineering, Japan; Glass Beads | | | |
| | GBL-30) | | | |
| Example 8 | Polystyrene particles | 50 | Ink 2 | A |
| | (manufactured by Ganz Chemical | | | |
| | Co., Ltd.; GANZ PEARL (trade | | | |
| | name) GM-5003) | | | |
| Example 9 | Acrylic particles | 18 | Ink 3 | A |
| | (manufactured by Toyobo Co., | | | |
| | Ltd.; TAFTIC (trade name) | | | |
| | AR650S) | | | |
| Example 10 | Divinylbenzene polymer particles | 30 | Ink 3 | A |
| | (manufactured by Sekisui Chemical | | | |
| | Co., Ltd.; MICROPEARL (trade | | | |
| | name) GS-230) | | | |
| Example 11 | Glass particles | 30 | Ink 3 | A |
| | (manufactured by the Association of | | | |
| | Powder Process Industry and | | | |
| | Engineering, Japan; Glass Beads | | | |
| | GBL-30) | | | |
| Example 12 | Polystyrene particles | 50 | Ink 3 | A |
| | (manufactured by Ganz Chemical Co., | | | |
| | Ltd.; GANZ PEARL (trade name) | | | |
| | GM-5003) | | | |
| Example 13 | Acrylic particles (manufactured by | 3 | Ink 1 | D |
| | JSR Co., SX8703(A)-02) | | | |
| Example 14 | Divinylbenzene polymer particles | 10 | Ink 1 | C |
| | (manufactured by Sekisui Chemical | | | |
| | Co., Ltd.; MICROPEARL (trade | | | |
| | name) SP-210) | | | |
| Example 15 | Acrylic particles (manufactured by | 3 | Ink 2 | D |
| | JSR Co., SX8703(A)-02) | | | |
| Example 16 | Divinylbenzene polymer particles | 10 | Ink 2 | C |
| | (manufactured by Sekisui Chemical | | | |
| | Co., Ltd.; MICROPEARL (trade | | | |
| | name) SP-210) | | | |
| Example 17 | Acrylic particles (manufactured by | 3 | Ink 3 | D |
| | JSR Co., SX8703(A)-02) | | | |
| Example 18 | Divinylbenzene polymer particles | 10 | Ink 3 | C |
| | (manufactured by Sekisui Chemical | | | |
| | Co., Ltd.; MICROPEARL (trade | | | |
| | name) SP-210) | | | |
| Example 19 | Wheat flour | 15 | Ink 1 | A |
| Example 20 | Edible starch | 30 | Ink 1 | A |
| Example 21 | baby powder (talc) | 10 | Ink 1 | C |
| Comparative | — | — | Ink 1 | E |
| Example 1 | | | | |
| Comparative | — | — | Ink 2 | E |
| Example 2 | | | | |
| Comparative | — | — | Ink 3 | E |
| Example 3 | | | | |

As shown in Table 2, in Examples 1 to 21, the transfer evaluation results were satisfactory as compared with in Comparative Examples 1 to 3 which used no powder. In particular, satisfactory transfer evaluation results were obtained in the cases using a powder with an average particle size of not less than 10 μm and especially satisfactory transfer evaluation results were obtained in the cases that using a powder with an average particle size of not less than 15 μm.

Examples 1 to 21 are each the first embodiment in which the recording method illustrated by FIG. 4 is implemented using the ink jet recording apparatus 100 shown in FIG. 1. It is conceivable that the surface area of the powder 3 is one of the reasons why good transfer evaluation results were obtained when the average particle size of the powder 3 was not less than 10 μm, in particular not less than 15 μm. The powder 3 movably adheres to the surface of the transporting roller 4 and rotates, etc., thereby changing the contact surface of the powder 3 contacting with the recording medium 1. With the powder with a smaller surface area (powder with a small average particle size), the ratio of the surface (surface with the possibility of being dirtied or stained), coming into contact with the recording surface, becomes greater with respect to the entire surface area of the powder. Therefore, when the transporting roller again transports the following recording medium, the probability is increased that a portion of the surface of the powder, which come into contact with the previous recording medium (another portion of the surface having the possibility of being dirtied or stained) comes into contact with the recording surface of the following recording medium.

On the other hand, for example, in a case that the recording method illustrated by FIG. 5 is implemented (second embodiment) by using the ink jet recording apparatus 200 shown in FIG. 2, the average particle size of the powder 3 causes no difference in the transfer evaluation results. The powder 3 which has once come into contact with the recording medium 1 is removed by the powder removal blade 10 from the transporting roller 4 and the new powder 3 is supplied to the transporting roller 4 at all times. Therefore, the effect is demonstrated regardless of the particle size of the powder.

What is claimed is:

1. An ink jet recording apparatus which records information on a medium by jetting an ink onto a recording surface of the medium, comprising:
an ink accommodation section which accommodates the ink;
a head which jets the ink onto the recording surface;
a transporting roller which transports the medium on which the information has been recorded; and
a powder supply mechanism which supplies a powder to the transporting roller.

2. The ink jet recording apparatus according to claim 1, wherein the transporting roller transports the medium on which the information has been recorded in a state that the powder is intervened between a surface of the transporting roller and the recording surface of the medium.

3. The ink jet recording apparatus according to claim 1, wherein the transporting roller transports the medium on which the information has been recorded in a state that the powder is movably adhered to a surface of the transporting roller.

4. The ink jet recording apparatus according to claim 1, wherein the transporting roller causes a part of the powder supplied to the transporting roller to adhere to the recording surface of the medium when the transporting roller transports the medium.

5. The ink jet recording apparatus according to claim 1, further comprising a powder recovery mechanism which recovers the powder supplied to the transporting roller.

6. The ink jet recording apparatus according to claim 5, further comprising a powder transport mechanism which transports the recovered powder to the powder supply mechanism.

7. The ink jet recording apparatus according to claim 1, further comprising:
a counter roller which transports, together with the transporting roller, the medium after the recording; and
a voltage application mechanism which applies a voltage to the transporting roller or the counter roller.

8. The ink jet recording apparatus according to claim 1, wherein the ink is a water-base ink and contains a pigment.

9. The ink jet recording apparatus according to claim 1, wherein the powder includes particles having an average particle size of 15 μm to 50 μm.

10. An ink jet recording method, comprising:
recording information on a medium by jetting an ink onto a recording surface of the medium;
supplying a powder to a transporting roller which transports the medium on which the information has been recorded; and
transporting the medium on which the information has been recorded by the transporting roller to which the powder has been supplied.

11. The ink jet recording method according to claim 10, when the medium on which the information has been recorded is transported by the transporting roller, the powder is intervened between a surface of the transporting roller and the recording surface of the medium.

12. The ink jet recording method according to claim 10, when the medium on which the information has been recorded is transported by the transporting roller, the powder is movably adhered to a surface of the transporting roller.

13. The ink jet recording method according to claim 10, comprising causing a part of the powder supplied to the transporting roller to adhere to the recording surface of the medium when the medium on which the information has been recorded is transported.

14. The ink jet recording method according to claim 10, further comprising recovering the powder supplied to the transporting roller.

15. The ink jet recording method according to claim 14, further comprising supplying the recovered powder again to the transporting roller.

16. The ink jet recording method according to claim 10, wherein the medium is transported by the transporting roller and a counter roller; and
the method further comprises applying a voltage to the transporting roller or the counter roller.

17. The ink jet recording method according to claim 10, wherein the ink is a water-base ink and contains a pigment.

18. The ink jet recording method according to claim 10, wherein the powder includes particles having an average particle size of 15 μm to 50 μm.
